(19) United States
(12) Patent Application Publication
(10) Pub. No.: US 2007/0282698 A1
(43) Pub. Date: Dec. 6, 2007

(54) DETERMINING MOST VALUABLE ORDERING OF ITEMS FOR PRESENTATION

(76) Inventors: Bernardo A. Huberman, Palo Alto, CA (US); Fang Wu, Pala Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/531,652

(22) Filed: Sep. 13, 2006

Related U.S. Application Data
(60) Provisional application No. 60/801,911, filed on May 19, 2006.

(51) Int. Cl. G06Q 30/00

(52) U.S. Cl. 705/26

(57) ABSTRACT

An automatic configuration mechanism generates the most relevant information to be presented to users of information-rich media. The mechanism also guarantees to maximize their total expected utility from the information they receive. A computationally efficient heuristic is used to assign an index value to each information item, which then determines whether or not a given item appears in the top list presented to users at a given time.

### CROSS-REFERENCE TO RELATED PATENT APPLICATION

This patent application claims priority under 35 U.S.C. §119 from U.S. provisional patent application No. 60/801,911 filed May 19, 2006 entitled “A System And Method For Selecting And Displaying Most Valuable Information,” with inventors Bernardo Huberman and Fang Wu, and which is hereby incorporated by reference.

### TECHNICAL FIELD

This invention pertains generally to ordering a set of items, and more specifically to determining a most valuable ordering for presentation where a restriction exists limiting output to a subset of the items.

### BACKGROUND

An interesting and daunting consequence of the prevalence of the web and digital media is that information, which used to be scarce and therefore valuable, is now so ubiquitous so as be almost devoid of monetary value. Search engines, billions of websites, targeted advertisements and easy access to digital content all provide us with myriad ways of taking care of our most complex informational and entertainment needs. What is now scarce, and therefore valuable, is the user's attention, which explains the intense efforts made at obtaining it through focused advertising, pop-ups, short videos embedded in news portals, and most dishearteningly, spam email.

The interaction between attention and information has been studied in fields from psychology to economics. Equilibrium models of the economics of attention have been developed that elucidate the interplay between the intensity of the information available to consumers and the amount of attention that they can devote to it. Specifically, it has been shown that when the information exposure of individuals is low, an information poor economy ensues in which there is no scarcity of attention. Conversely, an information rich economy with a consequent scarcity of attention is bound to appear whenever technology makes it easy to reach large number of individuals without raising costs, or when individual wealth increases.

An information-rich regime is characterized by a keen competition for the user's attention, resulting in a flood of information from which people often find it hard to sort out the most relevant and useful pieces. In addition, the law of surfing, which states that the probability of a user accessing a number of items in a single session markedly decreases as the number of items increases, puts a strong constraint on the amount of information that ever gets explored in a single surfing session.

Rather than leaving it up to the consumer to cope with this distracting overload, providers often try to present first the most salient items in their inventory while taking into account the visual real estate available on a given device. Search engines such as Google or Yahoo do not exhibit all their search results on one webpage, but rather prioritize and display them on consecutive pages the value of which is assumed to be decreasingly lower to the user. The same applies to large recommendation sites such as CNET, where items or stores are ranked and displayed according to the number of positive rankings they receive.

These approaches suffer from two problems. The first one resides with the content provider, who needs to decide what to prioritize in order to get the user's attention. This decision can be made on the basis of some objective criterion (page rank in search, number of recommendations for software, popularity of a site, saliency of news) or some heuristic rule that the content provider develops.

In either case it is not clear that such procedures maximize the user's value. For example, while an algorithm like page rank inserts the most linked-to pages in the first page of a query result, other links in other pages often contain incipiently valuable information that is not available to the user.

The second problem stems from the finite number of items that a user can attend to in a given time interval. Because of this, a user is more likely to explore the first few items presented to him. For example, there is empirical evidence that a typical user seldom visits pages beyond the first one in a search result, so that a page ranked at the bottom by a search engine is unlikely to be viewed by many users. This behavior tends to reinforce the leading position of those top-listed items and thereby further increase their popularity, which in turn penalizes new content that is not well known yet. Thus it is easy for an item to get locked in a top ranking, and hard for other bottom-listed items to surface, even though the latter can often be more valuable.

What is needed is a system and a method to break this distorting reinforcement process by encouraging users to explore more items, thus increasing on average the value they obtain. More specifically, an automatic configuration mechanism that maximizes user value in information rich environments would be desirable.

### SUMMARY OF INVENTION

Computer systems and computer-implemented methods determine an ordering for a set of items. An order determination manager measures item information for each item. The state information for an item can be determined by user activity indicating the popularity of an item, such as the frequency with which users access the item. The order determination manager also tracks rates at which items transition between states, for example by measuring changes in the popularity of items over time. At given times, the order determination manager orders the set of items based on the item states, the transition rates, and a discount rate, which indicates how much future time to account for in ordering the plurality of items.

In some instances, the order determination manager ranks the items for output to users. The output medium (for example, computer screen or cell phone display area) is often limited such that only a subset of the items can be displayed at a time. The limitation can also be one of time, where only a certain amount of time exists to output a subset of items (for example, play television commercials). In such instances, the order determination manager can rank the items by output priority, such that, for example, the most popular items are displayed on the screen initially, and the user can move down the list to view the less popular items. As the popularity of items changes over time, the order determination manager reorders the list accordingly. The problem of how to determine a desired ordering of the set of items can be solved by treating the problem as a dual-speed restless bandit problem, and applying a Niño-Mora heuristic to solve the dual-speed restless bandit problem.

The features and advantages described in this summary and in the following detailed description are not all-inclusive, and particularly, many additional features and advantages will be apparent to one of ordinary skill in the relevant art in view of the drawing, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram illustrating a high level overview of a system for the operation of one embodiment of the present invention.

FIG. 2A is a block diagram illustrating the operation of an order determination manager, according to some embodiments of the present invention.

FIG. 2B is a flowchart illustrating steps for ordering a set of items, according to some embodiments of the present invention.

FIG. 3 is a graph illustrating item states and the transition probabilities between them, according to some embodiments of the present invention.

FIG. 4 is a graph illustrating item states ranked by their G-indices, from highest to lowest, according to some embodiments of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

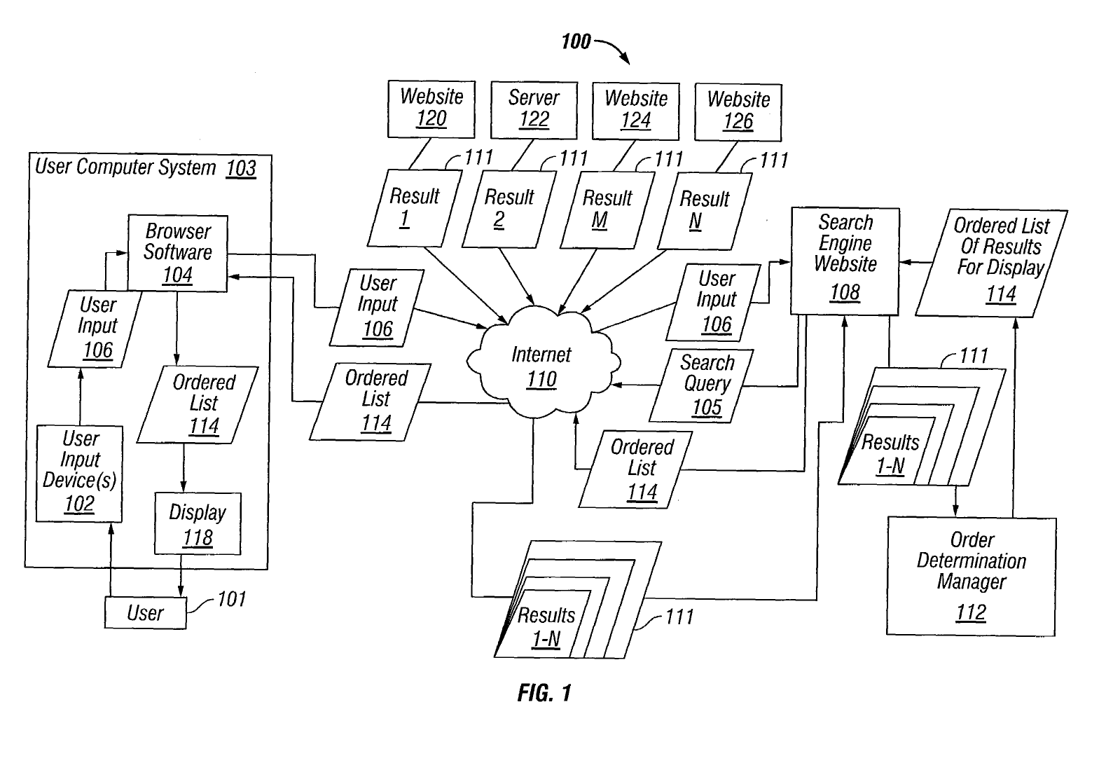

FIG. 1 illustrates an example system 100 in which an embodiment of the present invention can operate. A user 101 can operate a user input device 102 (for 2:1 example, a mouse or a keyboard) to enter user input 106 (for example, a search result) into a software program such as a browser 104 running on the user computer system 103. The user input 106 can be transmitted across a L network such as the Internet 110, to a remote computing system such as a search engine website 108. The search engine website 108 processes a search query 105 based on the user input 106 and receives results 111 over the Internet 110. The illustrative examples are Result 1 from a website 120, Result 2 from a server 122 (e.g., an ftp server), Result M from another website 124 and Result N from yet another website 126. The results are forwarded to an order determination manager 112 for determining an order of ranking of the results by executing functionality according to an embodiment of the present invention as described in detail below. The order determination manager 112 produces an ordered list 114 of results for display which are sent to the search engine website 108, which in turn sends the ordered list 114 formatted for display to the user computer's browser 104. The browser 104 displays the ordered list 114 on the display 118 of the user computer system 103. Alternatively, the ordered list 114 can be sent by the order determination manager 112 directly to the browser 104.

It is to be understood that FIG. 1 illustrates an example of a system 100 on which an embodiment of the present invention can execute, but as will be apparent to those of ordinary skill in the relevant art, many variations on the system 100 are possible and are within the scope of the present invention. For example, the illustrated components can be distributed in other ways and/or can be centralized or localized. The various computing devices illustrated are only examples, and different, more, or fewer computing devices are utilized in other embodiments. Typically, a plurality of users 101 will utilize the system 100, although only one is illustrated in FIG. 1 for clarity. As explained in detail below, the present invention is not limited to ordering results of search queries, and as such other destinations for user input are appropriate in other embodiments. Further, as the present invention is not limited to ordering a list for display, other types of output media are used in other embodiments as desired.

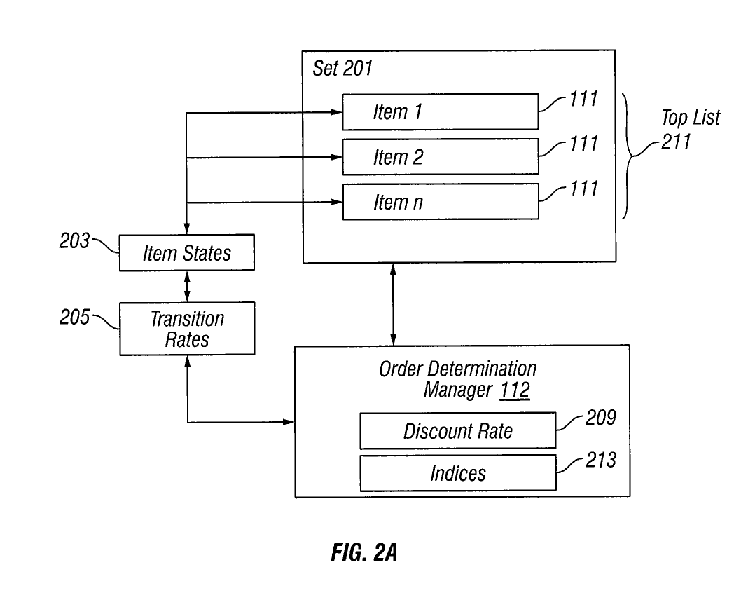

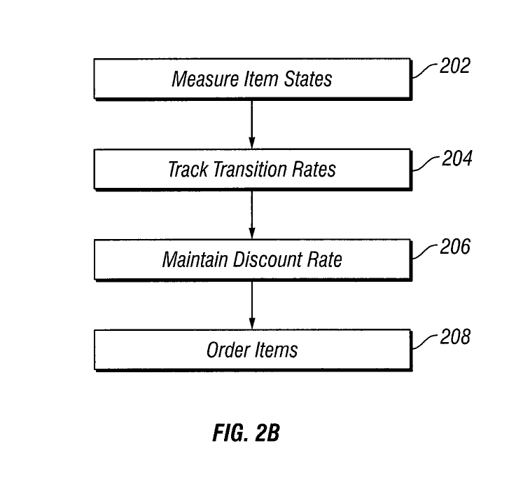

Turning now to FIG. 2A, according to some embodiments of the present invention the order determination manager 112 calculates an order in which to present a set 201 of items 111. It is to be understood that although the order determination manager 112 is illustrated as a single entity, as the term is used herein an order determination manager 112 refers to a collection of functionalities which can be implemented as software, hardware, firmware or any combination of these. Where an order determination manager 112 is implemented as software, it can be implemented as a standalone program, but can also be implemented in other ways, for example as part of a larger program or as a plurality of separate programs. Whether the order determination manager 112 is implemented as software, hardware, firmware or a combination of the three, it can be implemented as one or more modules as desired.

As described in greater detail below, the order determination manager 112 process a set 201 of items 111 (e.g., the results of a search query 105 as illustrated in FIG. 1) and determines an optimal order in which to rank the set 201 of items 111 in order to maximize utility for a plurality of users 101. For purposes of the present invention, the initial set 201 of items 111 is considered to be in a random order, although it can be in an ordering considered non-random to a party providing the set 201 (e.g., alphabetical order, ordered according to Google's page rank algorithm, etc.).

The order determination manager 112 determines state information 203 for each item 111 based on certain properties (determined, e.g., by user activity), as described in greater detail below. The order determination manager 112 measures the transition rates 205 of state 203 change for the items 111. The order determination manager 112 updates the ranking at discrete times based on the state 205 of the items 111, the state transition rates 205 of the items 111 and a discount rate 209 which is a function of how far into the future to account for when determining ranking the items 111.

More specifically, consider that the order determination manager 112 orders n different items 111 for a plurality of users 101, each of whom can only display up to k items 111 at any given time, where k<n. Since an item 111 displayed to a user 101 has a higher probability of being chosen than when it is not displayed, these k items 111 can be thought of as the “top list 211.” The order determination manager 112 can update its top list 211 at discrete times t=0, 1, 2, . . . .

By tracking properties for each item 111, such as its reputation, history, age, etc., the order determination manager 112 can determine that the item 111 is in a “state” 203 defined by those properties. Let E be the set of all possible states 203, i.e., all possible combinations of those trackable properties. In general, the state 203 of an item 111 may change as time goes on. As an example, on a software download site the number of downloads, or the average rating of a particular package, may vary from week to week.

It is to be understood that in various embodiments of the present invention, the order determination manager 102 uses various heuristics to determine the order of the items 111. Each such heuristic takes into account the state 203 of each item 111, the transition rates 205 of items 111 between states 203 and a discount rate 209. It will be readily understood by those of ordinary skill in the relevant art in light of this specification that the properties to use in order to determine states 203 as well as the discount rate to apply are variable design parameters, which can be set as desired in different embodiments of the present invention.

It can be assumed within the context of one embodiment of the present invention that the state 203 of each item 111 changes according to a Markov process independent of the state 111 of other items 111, with transition probabilities {Pᵢⱼ¹:i, j εE} if the item 111 is on the top list 211, and {Pᵢⱼ⁰:i, j εE} if it is not. It can also be assumed that an item 111 being on the top list 211 encourages more users 101 to select it, and consequently accelerates its transition from one state 203 to another. Conversely, when an item transitions away from the top list 211, its rate of change slows down by an amount εᵢ which is less than one. This dual speed assumption can be stated as

$${P}_{ij}^{0} = \{ \begin{matrix}{ɛ}_{i} {P}_{ij}^{1} , & i \neq j , \\ ( 1 - {ɛ}_{i} ) + {ɛ}_{i} {P}_{ii}^{1} , & i = j ,\end{matrix} \\ where {ɛ}_{i} ε [ 0 , 1 ] . \qquad ( 1 )$$

Consider the total expected utility rᵢ obtained in one time step by those users 101 who decide to access an item 111 on the top list 211 which has state i. This utility may depend on many factors, such as the total expected number of users 101 choosing the item 111 at a given time step, or the expected quality of the item 111. Since the definition of “state” 203 can be expanded to include these factors, the utility rᵢ is uniquely determined by the item state i. In other words, we can assume that r=(rᵢ)_{iεE} is an |E|-dimensional constant vector known by the order determination manager 112.

The order determination manager 112 can maximize the total expected utility of all users 101:

$${max}_{u ε U} {E}_{u} [ {\sum }_{i = 0}^{∞} {\sum }_{m = 1}^{η} {β}^{t} {r}_{{i}_{m} ( t )} {I}_{m} ( t ) ] \qquad ( 2 )$$

where iₘ(t) is the state 203 of item m at time t, and

$${I}_{m} ( t ) = \{ \begin{matrix}1 if item m is displayed at time t , \\ 0 otherwise\end{matrix} \} \qquad ( 3 )$$

where 0<β≦1 is the future discount factor 209. A solution is thus to find the optimal strategy, υ, in the space υ of stationary strategies (strategies that depend on current item states only). This strategy can then be translated into the set of offerings that are to appear in the top list 211.

The model described above is essentially a dual-speed restless bandit problem. Dual-speed restless bandit problems are discussed, for example, in P. Whittle (1988) Restless bandits: activity allocation in a changing world, J. Appl. Prob., 25A, pp 287-298 and K. D. Glazebrook, J. Niño-Mora and P. S. Ansell (2002) Index policies for a class of discounted restless bandits. Adv. Appl. Prob., 34, 754-774.

The model described above is restless because changes of state can also occur when the items are not displayed in the top list 211, and dual speed because those changes do happen at a different speed than those on the top list 211. As is known by those of ordinary skill in the relevant art, Bertsimas and Niño-Mora have demonstrated that an optimal solution is available for the dual-speed restless bandit problem. This solution is discussed in, e.g., J. Niño-Mora (2001) Restless bandits, partial conservation laws and indexability. Adv. Appl. Prob., 33, 76-98, as well as the Glazebrook et al. document cited above.

Specifically, it is possible to attach an index 213 to each item state 203, so that the top list 211 is the ordering including those items 111 with the largest indices 213. This way the user value gets maximized. It is worth remarking that it is not obvious why the relative importance of the states 203 can be measured by one independent index 213. In fact, for a general restless bandit problem without the dual-speed assumption, such a set of indices 213 may not exist.

Nevertheless, Bertsimas and Niño-Mora have shown that a relaxed version of the dual-speed problem is always indexable (i.e. such indices 213 always exist) and also proposed an efficient adaptive greedy heuristic to compute these indices 213. By relaxed we mean that instead of displaying exactly k items 111 at each time, k items 111 on average are displayed. For this relaxed problem, it can be shown that there exists a set of indices {Gᵢ}_{iεE} and a Lagrange multiplier γ such that the optimal strategy is to always display those items 111 whose G-index is greater than γ. Note that in situations where the top list 211 can have variations in the number of items 111, the relaxed situation is the one that applies. In embodiments that apply the limit of no variations, while the solution is known to be suboptimal, the solution is a good approximation to the optimal one, and thus still has great utility.

In order to apply the Bertsimas and Niño-Mora heuristic in this specific context, the order determination manager 112 first calculates a set of constants A^{S}ᵢ, which are herein defined. Assume that E is finite. For any subset SεE, we define the S-active policy υₛ to be the strategy that recommends all items 111 whose state 203 is in S. Now consider an item 111 that starts from an initial state X(0)=i. Under the action implied by strategy υₛ, its total occupancy time in S is given by

$$\begin{matrix}{V}_{i}^{s} = {E}_{{υ}_{s}} [ {\sum }_{t = 0}^{∞} {β}^{t} {I}_{S} ( t ) \text{\textbar} X ( 0 ) = i ] , \\ where & ( 4 ) \\ {I}_{S} ( t ) = \{ \begin{matrix}1 if X ( t ) ∈ S , \\ 0 otherwise .\end{matrix} & ( 5 )\end{matrix}$$

### We have

$${V}_{i}^{s} = \{ \begin{matrix}1 + β {\sum }_{j ∈ E}^{ } {P}_{ij}^{1} {V}_{j}^{s} , & i ∈ S , \\ β {\sum }_{j ∈ E}^{ } {P}_{ij}^{0} {V}_{j}^{S} , & i ∈ {S}^{c} .\end{matrix} \qquad ( 6 )$$

The variables {Vᵢ^{S}}iεE can be solved from the set of linear equations above. A matrix of constants {Aᵢ^{S}}iεE,S⊂E is defined by means of Vᵢ^{S} as follows:

$${A}_{i}^{S} = 1 + β {\sum }_{j ∈ E}^{ } {P}_{ij}^{1} {V}_{j}^{{S}^{c}} - β {\sum }_{j ∈ E}^{ } {P}_{ij}^{0} {V}_{j}^{{S}^{c}} . \qquad ( 7 )$$

### The constants {Aᵢ^{S}} are then used in the Bertsimas-Niño-Mora heuristic as indicated in table 1:

TABLE 1
Bertsimas-Niño-Mora adaptive greedy heuristic

Step 1. Set S_{|E|} = E and

(8)

${y}^{{S}_{\vert E \vert}} = max \{ \frac{{r}_{i}}{{A}_{i}^{E}} : i ∈ E \}$
Select π_{|E|} as any maximizer and set G_{π|E|} = y^{S}_{|E|}.
Step 2. For k = 2, 3, . . . , |E|, set S_{|E|-k+1} = S_{|E|-k+2}\{π_{|E|-k+2}} and

(9)

${y}^{{S}_{\vert E \vert - k + 1}} = \\ max \{ \frac{{r}_{i} - {\sum }_{j = 1}^{k - 1} {A}_{i}^{{S}_{\vert E \vert - j + 1}} {y}^{{S}_{\vert E \vert - j + 1}}}{{A}_{i}^{{S}_{\vert E \vert - k + 1}}} : i ∈ {S}_{\vert E \vert - k + 1} \} .$
Select π_{|E|-k+1} as any maximizer and set G_{π}_{_{|E|−k+1}} = G_{π}_{_{|E|−k+2}} + y^{S}^{_{|E|−k+1}}.

Once the order determination manager 112 computes the G-index for each state using this heuristic, the strategy is to display the k items 111 whose states 203 have the largest G-indices. For our dual-speed restless bandit problem, it follows that Aᵢ^{S}>0 for all iεE and S⊂E, so that the relaxed version of the problem is indexable. The table above also provides a good heuristic for the unrelaxed problem.

FIG. 2B illustrates a method for determining an ordering of a plurality of items. For illustrative purposes and not to be limiting thereof, FIG. 2B is discussed in the context of the order determination manager 112 of FIG. 2A. As illustrated by FIG. 2B, the order determination manager 112 measures 202 an item state 203 for each of a set 201 of items 111. The order determination manager 112 tracks 204 rates 205 at which the items 111 transition between item states 203. The order determination manager 112 further maintains 206 a discount rate 209 which indicates how much future time to account for in ordering the items 111. At discrete times, the order determination manager 112 orders 208 the items 111 based on the item states 203, the transition rates 205 and the discount rate 209.

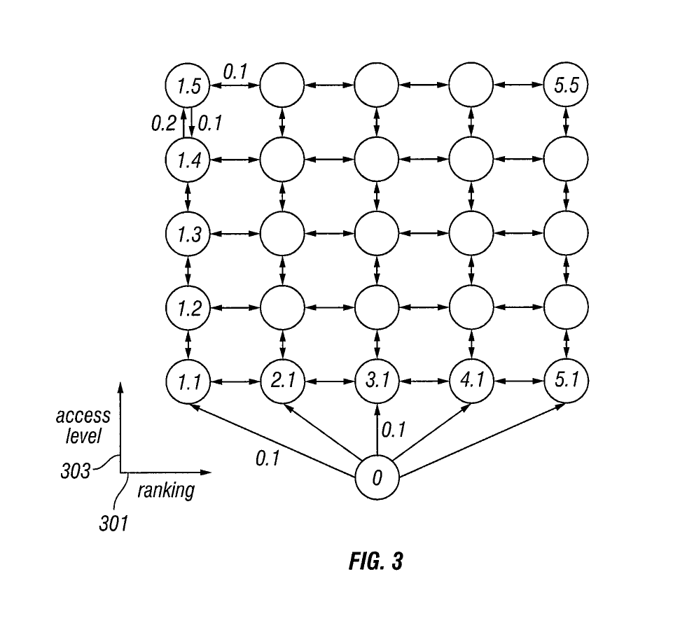

Turning to FIG. 3, the workings of the order detection manager 101 according to one embodiment is illustrated in the context of a simple example. Consider a website that can display k out of n items 111 at any given time, where k<n. Each item 111 can have a rating, of (for example) 1 to 5, with 5 denoting the highest rating and 1 the lowest. Each item 111 also has an access level from 1 to 5 indicating its click rate in one time step, with 5 denoting the most number of clicks received. The access levels can be set rather arbitrarily, e.g. level 1 for 1,000 clicks, level 2 for 2,000 clicks, level 3 for 5,000 clicks, etc. Hence each state can be represented as a 2-vector (s, a)ε{1, 2, 3, 4, 5}² where S is the rating and a is the access level.

In addition to those 25 states 203 there is one more state, 0, which we call the “unknown” state. Each item 111 initially starts in this state 203, as it has never been either accessed or rated. We assume that occasionally an item 111 will “die,” and if that happens it is immediately replaced by a new item 111. This is equivalent to assuming that there is a small transition probability from each of the 25 states to the unknown state, the entering of which implies starting over. State 0 thus serves as both the sink and the source.

The transition probabilities are assumed to be as follows:

$$\begin{matrix}\{ \begin{matrix}{P}^{1} ( s , a ; s + 1 , a ) = 0 , 1 ; & 1 \leq s \leq 4 , 1 \leq a \leq 5 \\ {P}^{1} ( s , a ; s - 1 , a ) = 0.1 ; & 2 \leq s \leq 5 , 1 \leq a \leq 5 \\ {P}^{1} ( s , a ; s , a + 1 ) = 0.2 , & 1 \leq s \leq 5 , 1 \leq a \leq 4 \\ {P}^{1} ( s , a ; s , a - 1 ) = 0.1 , & 1 \leq d \leq 5 , 2 \leq a \leq 5 \\ {P}^{1} ( s , a ; 0 ) = 0.01 , & 1 \leq s \leq 5 , 1 \leq a \leq 5 \\ {P}^{1} ( 0 ; s , 1 ) = 0.1 , & 1 \leq s \leq 5\end{matrix} \\ and & ( 10 ) \\ {ɛ}_{i} = 0.1 for all i ∈ E , & ( 11 )\end{matrix}$$

which expresses the fact that displaying an item 111 on the top list 211 accelerates its transition speed by ten times. Note the assumption that an item's access level tends to increase more than to decrease. The states 203 and the transition probabilities are illustrated in FIG. 3.

The order determination manager 112 sets the reward of each state 203 to be

$$\{ \begin{matrix}r ( s , a ) = s \cdot a , \\ r ( 0 ) = 0.\end{matrix} \qquad ( 12 )$$

### That is, items 111 on the website are rewarded in proportion to the number of clicks they receive and their ratings.

FIG. 3 illustrates the 26 states 203 and the transition probabilities P¹ between them. The horizontal axis 301 denotes the ratings, and the vertical axis 305 the five possible access levels. What is not shown in the figure is that every state in the 5×5 grid transits to state 0 with a small probability 0.1.

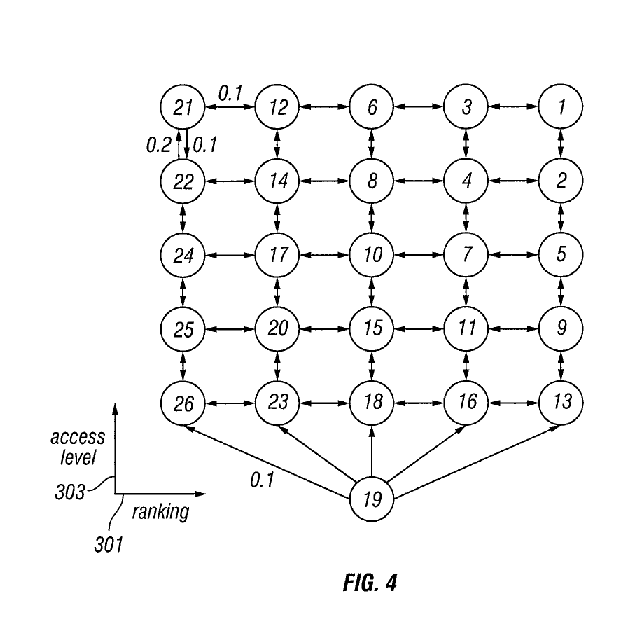

The G-index rankings of the 26 states 203 are calculated using the above described Bertsimas-Niño-Mora heuristic. The result is shown in FIG. 4. As can be seen state (5,5) has the largest G-index, state (5,4) the second largest, and so on. The absolute values of the indices 213 are not as important as their relative orders. Those items 111 that acquire the largest G-index value are the ones to be displayed to the user 101.

The result of this example is by no means trivial. For example, it is not obvious that the unknown state 203 which gives no reward should have higher display priority than state (2,2), but lower priority than (3,1). This effect is due to the fact that the heuristic gives high index values to potentially valuable states 203. The mechanics of this example can be extended to larger systems and used to compute the transition probabilities from actual data from a portal.

FIG. 4 illustrates the 26 states 203 ranked by their G-indices 213, from highest to lowest. For example, the state (5,5) on the top right corner has the highest G-index of 1 and the state (1,1) on the lower left corner has the lowest G-index of 26. Thus, in the example of results returned from a query for display, the item whose item state is associated with the index of 1 will be displayed at the top of the list (e.g., 211), and the item whose item state is associated with the index of 26 will be displayed last in the list.

This solution utilizes on the computation of a set of indices 213, each allocated to each item state 203 in a list, which can be computed by accessing the rates at which items 111 are visited and the rankings they receive from users 101. These rates determine the transition probabilities that are then used as inputs into the actual computation of the index 213 for each state 203. The actual computation of these indices 213 can be performed by mapping the problem of optimizing the information received from any other digital content to that of the optimal allocation of effort to a number of competing projects. Thus, as noted above, the problem to solve can be formulated as a dual-speed restless bandit problem, which is a special case of the restless multi-arm bandit problem. By specially applying in this context the computationally efficient heuristic developed by Bertsimas and Niño-Mora, it is possible to calculate an index 213 for each item state 203.

This mechanism can be used to solve a multiplicity of problems, ranging from the decision of which search results to display on the top list page 211 of a search engine, to the menu of items that a portal decides to present to users or the order in which a journal presents its content to users. Other applications include determining what to display in devices with a small visual real estate (e.g., cell phones, personal digital assistants), the relevant information that should be presented to analysts confronted with mountains of data, how to sort through blogs and other forms of user generated media, and the determination of how to best optimize movie and video directories. Another area of application is that of instrumentation, the purpose of which is to inform the user of the state of the world in which it is embedded. Furthermore, advertising is another potential beneficiary of this technology, for it could use click patterns from visitors to given portals to decide on which ads to present at given times. It is to be further understood that embodiments of the present invention can not only determine ordering of items to display in a limited space, but can also determine items to present in a limited time, for example which television or radio commercials to broadcast.

As will be understood by those familiar with the art, the invention may be embodied in other specific forms without departing from the spirit or essential characteristics thereof. Likewise, the particular naming and division of the modules, agents, managers, functions, procedures, actions, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, agents, managers, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

What is claimed is:

1. A computer implemented method for determining an ordering of a plurality of items, the method comprising the steps of:
measuring item state for each item of the plurality;
tracking rates at which items of the plurality transition between item states;
maintaining a discount rate which indicates how much future time to account for in ordering the plurality of items; and
at a plurality of discrete times, ordering the plurality of items based on the item states, the transition rates, and the discount rate.

2. The method of claim 1, wherein measuring an item state further comprises:
measuring user activity concerning an item such that an item state is a function of at least one item's desirability to users.

3. The method of claim 2, wherein measuring an item state further comprises:
measuring at least frequency of access of an item by at least one user.

4. The method of claim 2, wherein tracking rates at which items of the plurality transition between item states further comprises:
tracking changes concerning an item's desirability to users over time.

5. The method of claim 1, wherein ordering the plurality of items further comprises:
ordering each item of a plurality for output to at least one user, such that an item with a highest output priority is ranked with a highest ranking, and items with regressively lower output priorities are ranked with accordingly lower rankings; and
wherein an output limitation determines that only a subset of the items can be output with a first output priority.

6. The method of claim 5, wherein the output limitation is one from a group of output limitations consisting of:
a physical limitation in space of an output medium; and
a limitation in time in which to output items.

7. The method of claim 1 wherein ordering the plurality of items further comprises:
wherein an output limitation determines that only a subset of the items can be output with a first output priority;
treating a problem of how to determine an ordering of the plurality of items as a dual-speed restless bandit problem; and
applying a Niño-Mora heuristic to solve the dual-speed restless bandit problem.

8. At least one computer readable medium containing a computer program product for determining an ordering of a plurality of items, the computer program product comprising:
program code for measuring item state for each item of the plurality;
program code for tracking rates at which items of the plurality transition between item states;
program code for maintaining a discount rate which indicates how much future time to account for in ordering the plurality of items; and
program code for, at a plurality of discrete times, ordering the plurality of items based on the item states, the transition rates, and the discount rate.

9. The computer program product of claim 8, wherein the program code for measuring an item state further comprises:
program code for measuring user activity concerning an item such that an item state is a function of at one least item's desirability to users.

10. The computer program product of claim 9, wherein the program code for measuring an item state further comprises:
program code for measuring at least frequency of access of an item by at least one user.

11. The computer program product of claim 9, wherein the program code for tracking rates at which items of the plurality transition between item states further comprises:
program code for tracking changes concerning an item's desirability to users over time.

12. The computer program product of claim 8, wherein an output limitation determines that only a subset of the items can be output with a first output priority, and wherein the program code for ordering the plurality of items further comprises:
program code for ordering each item of a plurality for output to at least one user, such that an item with a highest output priority is ranked with a highest ranking, and items with regressively lower output priorities are ranked with accordingly lower rankings.

13. The computer program product of claim 12, wherein the output limitation is one from a group of output limitations consisting of:
a physical limitation in space of an output medium; and
a limitation in time in which to output items.

14. The computer program product of claim 8 wherein an output limitation determines that only a subset of the items can be output with a first output priority, and wherein the program code for ordering the plurality of items further comprises:
program code for treating a problem of how to determine an ordering of the plurality of items as a dual-speed restless bandit problem; and
program code for applying a Niño-Mora heuristic to solve the dual-speed restless bandit problem.

15. A computer system for determining an ordering of a plurality of items, the computer system comprising:
a module configured to measure item state for each item of the plurality;
a module configured to track rates at which items of the plurality transition between item states;
a module configured to maintain a discount rate which indicates how much future time to account for in ordering the plurality of items; and
a module configured to, at a plurality of discrete times, order the plurality of items based on the item states, the transition rates, and the discount rate.

16. The computer system of claim 15, wherein the module configured to measure an item state further comprises:
a module configured to measure user activity concerning an item such that an item state is a function of at one least item's desirability to users.

17. The computer system of claim 16, wherein the module configured to track rates at which items of the plurality transition between item states further comprises:
a module configured to track changes concerning an item's desirability to users over time.

18. The computer system of claim 15, wherein an output limitation determines that only a subset of the items can be output with a first output priority, and wherein the module configured to order the plurality of items further comprises:
a module configured to order each item of a plurality for output to at least one user, such that an item with a highest output priority is ranked with a highest ranking, and items with regressively lower output priorities are ranked with accordingly lower rankings.

19. The computer system of claim 18, wherein the output limitation is one from a group of output limitations consisting of:
a physical limitation in space of an output medium; and
a limitation in time in which to output items.

20. The computer system of claim 15 wherein an output limitation determines that only a subset of the items can be output with a first output priority, and wherein the module configured to order the plurality of items further comprises:
a module configured to treat a problem of how to determine an ordering of the plurality of items as a dual-speed restless bandit problem; and
a module configured to apply a Niño-Mora heuristic to solve the dual-speed restless bandit problem.
